(19) United States
(12) Patent Application Publication
(10) Pub. No.: US 2026/0308070 A1
(43) Pub. Date: Oct. 8, 2026

(54) SINTERING ADDITIVES FOR IMPROVED MICROSTRUCTURE CONTROL

(71) Applicant: UT-Battelle, LLC, Oak Ridge, TN (US)

(72) Inventors: Christopher A. HOBBS, Oak Ridge, TN (US); James M. KURLEY, III, Oak Ridge, TN (US); Rodney D. HUNT, Oak Ridge, TN (US)

(21) Appl. No.: 19/640,778

(22) Filed: Apr. 7, 2026

Related U.S. Application Data
(60) Provisional application No. 63/784,892, filed on Apr. 7, 2025.

(51) Int. Cl. C04B 35/515; C04B 35/624; C04B 35/63; C04B 35/64; G21C 3/58

(52) U.S. Cl. CPC C04B 35/5156; C04B 35/624; C04B 35/6303; C04B 35/64; G21C 3/58; C04B 2235/32; C04B 2235/3852; C04B 2235/443; C04B 2235/444; C04B 2235/528; C04B 2235/6567

(57) ABSTRACT

A precursor composition, fuel kernel, coated fuel particle, and method for producing uranium nitride nuclear fuel kernels are provided. The precursor composition includes uranyl nitrate, a carbon source, and a sintering additive comprising a salt having an additive cation and an additive anion, where the additive cation includes zirconium, hafnium, gadolinium, or combinations thereof. The precursor composition may be used in a sol-gel process to form gelled microspheres. The microspheres are heated in a nitrogen-containing atmosphere to convert the microspheres to uranium nitride kernels. The kernels may exhibit high density and may be incorporated into coated fuel particles including one or more coating layers. Methods include preparing a uranyl nitrate solution, preparing a feedstock including hexamethylenetetramine, urea, and a carbon source, gelation, and carbothermic reduction-nitridation.

### CROSS-REFERENCE TO RELATED APPLICATIONS

This application claims the benefit of U.S. Provisional Application 63/784,892, filed on Apr. 7, 2025, the disclosures of which are incorporated by reference in their entirety.

### STATEMENT REGARDING FEDERALLY SPONSORED RESEARCH AND DEVELOPMENT

This invention was made with government support under Contract No. DE-AC05-000R22725 awarded by the U.S. Department of Energy. The government has certain rights in the invention.

### FIELD OF THE INVENTION

The present invention relates to the field of nuclear fuel fabrication, and more specifically to precursor compositions, nuclear fuel kernels, coated fuel particles, and methods for producing uranium nitride nuclear fuel kernels using additive-enhanced sol-gel processing.

### BACKGROUND OF THE INVENTION

Particle dispersion fuels, particularly tristructural isotropic (TRISO) fuels, have garnered increased interest for nuclear power generation in advanced reactor concepts and space nuclear applications. Typical TRISO particles use a uranium carbide and uranium oxide (UCO) fuel kernel as their uranium source. However, UCO has several disadvantages relative to uranium mononitride (UN), including poor thermal conductivity of the majority UO₂ phase, lower melting points of the uranium monocarbide (UC) or uranium dicarbide (UC₂) phase(s), and lower uranium density for both phases. These thermophysical properties make UN an attractive candidate to replace UCO as the fuel kernel material, although such replacement would require high-density kernels.

Fuel kernel synthesis typically starts with a microsphere precursor synthesized using sol-gel chemistry. Two common methods are internal gelation and external gelation. Internal gelation utilizes a temperature-sensitive base, hexamethylenetetramine (HMTA), to trigger gelation of an acid deficient uranyl nitrate (ADUN) solution when heated. External gelation uses an ammonia gas stream to cause the ADUN to gel, which requires specialized equipment for safe handling.

Microsphere synthesis is only the first stage of fabricating fuel kernels; the microspheres must undergo conversion to the final uranium-bearing ceramic. For UO₂, high-density kernels can be achieved by heating to 1400° C. to 1550° C. in flowing argon-hydrogen mixtures. However, UN requires higher temperatures and a specialized temperature and gas profile to achieve density above 90%. Conventional conversion profiles can take over one day to complete, limiting overall throughput.

### SUMMARY OF THE INVENTION

A precursor composition for forming a uranium nitride nuclear fuel is provided. The precursor composition comprises a uranium source, a carbon source, and a sintering additive. The sintering additive is selected from the group consisting of: (i) a metal oxide; (ii) a salt including an additive cation and an additive anion; and (iii) combinations thereof. The (i) metal oxide is selected from the group consisting of zirconium dioxide, hafnium oxide, gadolinium oxide, and combinations thereof. The additive cation is selected from the group consisting of zirconium, hafnium, gadolinium, and combinations thereof.

A uranium nitride nuclear fuel kernel is also provided. The uranium nitride nuclear fuel kernel is prepared from the precursor composition by carbothermic reduction-nitridation.

A nuclear fuel particle is also provided. The nuclear fuel particle comprises the uranium nitride nuclear fuel kernel and one or more coating layers surrounding the kernel.

A method of preparing a uranium nitride nuclear fuel kernel is also provided. The method comprises preparing a uranium source; preparing a feedstock comprising hexamethylenetetramine, urea, and a carbon source; combining a sintering additive and the uranium source to form an additive solution; combining the additive solution and the feedstock to form a gelation broth, forming droplets of the gelation broth; gelling the droplets of the gelation broth to form gelled microspheres; and heating the gelled microspheres in a nitrogen-containing atmosphere to convert the gelled microspheres to a uranium nitride nuclear fuel. The sintering additive is selected from the group consisting of: (i) a metal oxide; (ii) a salt including an additive cation and an additive anion; and (iii) combinations thereof. The (i) metal oxide is selected from the group consisting of zirconium dioxide, hafnium oxide, gadolinium oxide, and combinations thereof. The additive cation is selected from the group consisting of zirconium, hafnium, gadolinium, and combinations thereof.

These and other features of the invention will be more fully understood and appreciated by reference to the description of the embodiments and the drawings.

### BRIEF DESCRIPTION OF THE DRAWINGS

FIG. 1 is a flowchart depicting an order of operations for producing high density uranium nitride nuclear fuel kernels.

FIG. 2 is a thermogravimetric analysis graph depicting a temperature profile and normalized mass change data for various carbon solutions.

FIG. 3 is a set of thermogravimetric graphs depicting mass change and temperature-dependent mass change during conversion of uranium nitride kernels prepared with zirconium-chloride- and zirconium-nitrate-based additives under different conversion profiles.

FIG. 4A is a thermogravimetric graph depicting a temperature profile and mass change during conversion of uranium nitride kernels prepared with Ti-chloride, Zr-chloride, and Hf-chloride additives using a rapid conversion profile.

FIG. 4B is a thermogravimetric graphs depicting a temperature profile and mass change during conversion of uranium nitride kernels prepared with Ti-chloride, Zr-chloride, and Hf-chloride additives using a slower conversion profile.

FIG. 5A is a set of X-ray diffraction scans of Ti-doped, Zr-doped, and Hf-doped uranium nitride kernels converted using a rapid conversion profile.

FIG. 5B is a graphical depiction of fractions of uranium present in UO₂ and UN_{1.5} impurity phases for the kernels of FIG. 5A.

FIG. 6 is a set of thermogravimetric graphs depicting a temperature profile and mass change during conversion of uranium nitride kernels prepared with U-chloride, Gd-chloride, and NH₄-chloride additives using a rapid conversion profile.

FIG. 7 is a set of X-ray diffraction scans of uranium nitride kernels prepared with U-chloride, Gd-chloride, and NH₄-chloride additives.

FIG. 8 is a thermogravimetric graph depicting a temperature profile and mass change during conversion of uranium nitride kernels prepared without additive, with zirconium nitrate additive, and with gadolinium nitrate additive.

FIG. 9 is a set of X-ray diffraction scans of uranium nitride kernels prepared without additive, with zirconium nitrate additive, and with gadolinium nitrate additive.

FIG. 10 is a thermogravimetric graph depicting a temperature profile and mass change during conversion of Hf-doped uranium nitride kernels using different ultrahigh-purity argon purge times after nitridation.

FIG. 11A is a set of X-ray diffraction scans of Hf-doped uranium nitride kernels prepared using different ultrahigh-purity argon purge times after nitridation.

FIG. 11B is a graphical depiction of impurity phase fraction and density as a function of argon purge time for the Hf-doped uranium nitride kernels of FIG. 11A.

FIG. 12 is a graphical depiction of percent theoretical uranium nitride density and absolute density as a function of relative lattice parameter difference and lattice parameter for additive nitride species.

### DETAILED DESCRIPTION OF THE CURRENT EMBODIMENTS

As discussed herein, the current embodiments relate to a precursor composition for forming a uranium nitride nuclear fuel. The precursor composition includes a uranium source, a carbon source, and a sintering additive. The sintering additive is selected from the group consisting of (i) a metal oxide; (ii) a salt; and (iii) combinations of (i) and (ii). The metal oxide is selected from the group consisting of zirconium dioxide, hafnium oxide, gadolinium oxide, and combinations thereof.

The precursor composition may be formulated as a solution, a suspension, a mixture, a broth, or another flowable composition suitable for forming precursor microspheres that are subsequently converted to uranium nitride nuclear fuel. In some embodiments, the precursor composition is configured for use in a sol-gel process, such as an internal gelation process, in which the precursor composition is formed into droplets and gelled to provide microspheres for subsequent thermal conversion. The precursor composition may be homogeneous or substantially homogeneous prior to droplet formation, such that constituents of the precursor composition are distributed throughout the precursor composition and, after gelation, throughout the resulting microspheres. In this way, the precursor composition may provide a precursor architecture that promotes formation of uranium nitride kernels having comparatively high density, improved phase composition, and/or improved microstructural uniformity following conversion.

The precursor composition includes a uranium source. The uranium source is selected from the group consisting of uranyl nitrate, uranyl chloride, uranium dioxide, and combinations thereof. The precursor composition can be uranyl nitrate. In some embodiments, the uranyl nitrate is present in solution form. For example, the uranyl nitrate may be present in an aqueous solution, an aqueous acidic solution, or an aqueous nitric acid solution. In certain embodiments, the uranyl nitrate solution comprises an acid deficient uranyl nitrate solution. The uranyl nitrate solution may be prepared from a uranium oxide feedstock. In some forms, uranium trioxide is thermally reduced to triuranium octoxide and the triuranium octoxide is dissolved in nitric acid and deionized water to provide the uranyl nitrate solution. In specific embodiments, residual solids are allowed to settle and the uranyl nitrate solution is decanted. In some embodiments, the uranyl nitrate solution has a uranium concentration of 0.5 M to 2.5 M, 1.0 M to 2.0 M, 1.2 M to 1.5 M, or 1.25 M to 1.35 M. In particular embodiments, the uranyl nitrate solution has a uranium concentration of 1.30 M. In some forms, the uranyl nitrate solution is chilled prior to combination with one or more additional precursor components.

The precursor composition includes a carbon source. The carbon source can be provided in a solution comprising hexamethylenetramine, urea, and distributed carbon. In some embodiments, the carbon source is present in a solution, such as a gelation feedstock solution that further includes hexamethylenetetramine and urea. In certain forms, the carbon source comprises a soluble carbon-containing composition configured to be combined with the uranyl nitrate and, in some instances, to remain distributed throughout the resulting broth and gelled microspheres. The carbon source may comprise one or more dissolved, dispersed, suspended, emulsified, or otherwise flowable carbon-containing materials. By way of example, suitable carbon-containing materials may include carbon-containing organic compounds, polymeric carbon precursors, resinous carbon precursors, carbohydrates, saccharides, polysaccharides, alcohols, polyols, glycols, organic acids, salts of organic acids, amides, aldehydes, ketones, esters, carboxylates, citrates, acetates, oxalates, lactates, malates, tartrates, ascorbates, phenolics, furans, polyacrylonitrile precursors, pitch-derived materials, carbohydrate-derived materials, or combinations thereof. In various embodiments, the carbon source is provided as a standardized soluble carbon solution having a selected carbon concentration. In particular embodiments, the carbon source is provided in a solution comprising hexamethylenetetramine and urea. In certain forms, hexamethylenetetramine and urea act as gelation components, carbon-containing components, or both. In specific embodiments, one or both of the hexamethylenetetramine and the urea may be replaced in whole or in part by another gelation aid, amine-containing compound, nitrogen-containing organic compound, pH-modifying compound, formaldehyde-releasing compound, or combinations thereof. In some forms, the solution comprising the carbon source further comprises water, such as deionized water.

In certain embodiments, the carbon source is present in an amount effective to provide a selected carbon-to-uranium ratio in the precursor composition. In some forms, the carbon-to-uranium ratio is 1:1 to 3:1. In various embodiments, the carbon-to-uranium ratio is 1.5:1 to 2.8:1, 1.8:1 to 2.6:1, 2.0:1 to 2.4:1, or 2.1:1 to 2.3:1. In particular embodiments, the carbon-to-uranium ratio is 2.2:1. In some embodiments, the feedstock comprising hexamethylenetetramine, urea, and the carbon source is prepared such that the carbon source provides a carbon concentration of 2.0 M to 8.0 M, 3.0 M to 7.0 M, 4.0 M to 6.0 M, or 5.0 M to 5.8 M. In specific embodiments, the carbon source provides a carbon concentration of 5.415 M. In certain embodiments, the hexamethylenetetramine is present at a concentration of 1.0 M to 5.0 M, 2.0 M to 4.0 M, 2.5 M to 3.5 M, or 3.0 M to 3.3 M. In particular embodiments, the hexamethylenetetramine is present at a concentration of 3.2 M. In some forms, the urea is present at a concentration of 1.0 M to 5.0 M, 2.0 M to 4.0 M, 2.5 M to 3.5 M, or 3.0 M to 3.3 M. In specific embodiments, the urea is present at a concentration of 3.2 M. In various embodiments, the feedstock including the carbon source, hexamethylenetetramine, and urea is diluted with water to a selected volume and mixed to provide a substantially uniform solution prior to combination with the uranyl nitrate.

The precursor composition includes a sintering additive. The sintering additive is selected from the group consisting of (i) a metal oxide); (ii) a salt; and (iii) combinations of (i) and (ii). The (i) metal oxide is selected from the group consisting of zirconium dioxide, hafnium oxide, gadolinium oxide, and combinations thereof. The (ii) salt includes an additive cation and an additive anion. The additive cation is selected from the group consisting of zirconium, hafnium, gadolinium, and combinations thereof.

The sintering additive can comprise a salt including an additive cation and an additive anion. The additive cation is selected from the group consisting of zirconium, hafnium, gadolinium, and combinations thereof. In some embodiments, the additive cation is selected from the group consisting of zirconium, hafnium, and combinations thereof. In certain embodiments, the additive cation is zirconium. In certain embodiments, the additive cation is hafnium. In other embodiments, the additive cation is gadolinium. In still other embodiments, the sintering additive comprises two or more additive cations selected from zirconium, hafnium, and gadolinium. For example, the sintering additive may comprise zirconium and hafnium, zirconium and gadolinium, hafnium and gadolinium, or zirconium, hafnium, and gadolinium. In some forms, the additive cation is present in a dissolved form in the precursor composition such that the additive cation is distributed throughout the precursor composition before gelation and is correspondingly distributed throughout the gelled microspheres after gelation.

In some embodiments, the additive anion is selected from the group consisting of chloride, nitrate, and combinations thereof. In certain forms, the additive anion is chloride. In specific embodiments, the additive anion is nitrate. In particular embodiments, the sintering additive comprises a chloride salt of zirconium, a chloride salt of hafnium, a chloride salt of gadolinium, a nitrate salt of zirconium, a nitrate salt of gadolinium, or a combination thereof. By way of example, and without limitation, suitable sintering additives may include zirconium tetrachloride, hafnium tetrachloride, gadolinium trichloride, gadolinium nitrate, zirconyl nitrate, hydrates thereof, solvates thereof, and combinations thereof. In some embodiments, the additive anion is selected to facilitate dissolution of the sintering additive in an aqueous medium, an aqueous acidic medium, or an aqueous nitric acid or hydrochloric acid-containing medium prior to combination with the uranyl nitrate and the carbon source.

In certain embodiments, the sintering additive is introduced as an additive solution. The additive solution may comprise water, one or more mineral acids, or both. In certain forms, the additive solution comprises deionized water and a corresponding acid selected to match the additive anion. For example, nitrate-based salts may be dissolved in the presence of nitric acid, and chloride-based salts may be dissolved in the presence of hydrochloric acid. In some embodiments, a concentrated acid is diluted before use in preparing the additive solution. In various embodiments, the acid concentration of the additive solution is from 0.1 M to 8 M, from 0.5 M to 6 M, from 1 M to 5.5 M, or from 3 M to 5 M. In particular embodiments, a hydrochloric acid stock solution or a nitric acid stock solution is prepared at 5 M and is used in preparing the additive solution.

In particular embodiments, the additive cation is present in the precursor composition in an amount of 0.5 atomic % to 5 atomic % relative to uranium. In various embodiments, the additive cation is present in an amount of 0.75 atomic % to 4.5 atomic % relative to uranium, 1.0 atomic % to 4.0 atomic % relative to uranium, 1.25 atomic % to 3.0 atomic % relative to uranium, or 1.5 atomic % to 2.5 atomic % relative to uranium. In certain embodiments, the additive cation is present in an amount of about 1.74 atomic % relative to uranium. In some forms, the foregoing atomic percentage refers to total additive cation content relative to total uranium content in the precursor composition. Where more than one additive cation is present, the combined amount of the additive cations may be 0.5 atomic % to 5 atomic % relative to uranium, and each individual additive cation may independently be present in an amount of 0.1 atomic % to 4 atomic %, 0.25 atomic % to 3 atomic %, or 0.5 atomic % to 2.5 atomic % relative to uranium.

In some embodiments, the additive solution is prepared at a selected cation concentration before addition to the precursor composition. In various forms, the additive cation concentration in the additive solution is from 0.05 M to 3.0 M, from 0.1 M to 2.5 M, from 0.25 M to 2.0 M, or from 0.5 M to 1.5 M. In certain embodiments, the additive cation concentration in the additive solution is 1.0 M. In some embodiments, the additive anion concentration in the additive solution is selected according to the identity of the additive anion. For example, where the additive anion is nitrate, the additive anion concentration may be from 0.5 M to 6.0 M, from 1.0 M to 5.0 M, from 2.0 M to 4.0 M, or from 2.5 M to 3.5 M. In particular embodiments, the nitrate concentration is 3.0 M. Where the additive anion is chloride, the additive anion concentration may be from 1.0 M to 8.0 M, from 2.0 M to 7.0 M, from 3.0 M to 6.0 M, or from 4.0 M to 5.5 M. In particular embodiments, the chloride concentration is 4.75 M.

A uranium nitride nuclear fuel prepared from the precursor composition by carbothermic reduction-nitridation is further provided. The uranium nitride nuclear fuel may be a nuclear fuel kernel. In some embodiments, the uranium nitride nuclear fuel kernel comprises uranium mononitride as a predominant phase. In various embodiments, the kernel further comprises one or more secondary phases, residual phases, additive-containing phases, or combinations thereof. For example, the kernel may comprise one or more phases including uranium, nitrogen, carbon, oxygen, zirconium, hafnium, gadolinium, or combinations thereof. In some forms, the additive cation remains associated with the kernel following carbothermic reduction-nitridation and contributes to densification behavior, phase evolution, microstructural development, or combinations thereof during conversion.

In certain embodiments, the uranium nitride nuclear fuel kernel has a density of at least 10 g/cm³, at least 11 g/cm³, or at least 12 g/cm³. In certain forms, the kernel has a density of 12 g/cm³ to 14.5 cm³, 12.2 cm³ to 14.2 cm³, or 12.5 cm³ to 14.0 g/cm³. In particular embodiments, the kernel has a density of at least about 12.5 g/cm³, at least about 13.0 g/cm³, or at least about 13.5 g/cm³. In particular embodiments, the kernel has a density below theoretical density but sufficiently high for use as a nuclear fuel kernel in a coated particle fuel system. As used herein, the term “theoretical density” means the density of a fully dense material of a given composition, as determined from the crystallographic density of that composition and assuming the absence of porosity or other internal volume defects. Thus, where a uranium nitride nuclear fuel kernel is described as having a density relative to theoretical density, the comparison is to a fully dense uranium nitride material of corresponding composition. In some embodiments, the uranium nitride nuclear fuel kernel has a density that is at least 75% of theoretical density, at least 80% of theoretical density, at least 85% of theoretical density, or at least 90% of theoretical density. In certain forms, the sintering additive promotes densification of the kernel during carbothermic reduction-nitridation relative to an otherwise corresponding precursor composition lacking the sintering additive.

In some embodiments, the uranium nitride nuclear fuel kernel has an average kernel diameter of 100 microns to 1500 microns, 200 microns to 1200 microns, 300 microns to 1000 microns, or 400 microns to 900 microns. In certain forms, the kernel has a diameter selected for subsequent application of one or more coating layers. In various embodiments, the kernel exhibits reduced cracking, reduced internal void content, improved structural integrity, improved sphericity, or combinations thereof following conversion. In some forms, the kernel is suitable for handling, classification, coating, and incorporation into a fuel compact or other nuclear fuel form.

In some embodiments, the uranium nitride nuclear fuel kernel is substantially spherical. As used herein, the term “substantially spherical” refers to a particle or kernel having an overall geometry approximating that of a sphere, while permitting minor departures from a mathematically perfect sphere. Examples of such departures include slight surface irregularities, localized depressions or protrusions, minor eccentricity, and other shape variations arising during droplet formation, gelation, drying, or thermal conversion. In certain forms, the kernel retains a spherical or substantially spherical geometry derived from the gelled microspheres from which it is produced. The kernel may have a generally uniform composition, a generally uniform distribution of additive-derived species, and a microstructure suitable for subsequent coating operations. In some embodiments, the kernel is configured for incorporation into a coated nuclear fuel particle, such as a TRISO-type fuel particle or another multilayer coated particle configuration.

A nuclear fuel particle including the nuclear fuel kernel and one or more coating layers surrounding the kernel is further provided. In certain forms, the one or more coating layers comprise one or more carbon-containing coating layers, one or more carbide-containing coating layers, one or more nitride-containing coating layers, one or more oxide-containing coating layers, or combinations thereof. In particular implementations, the one or more coating layers comprise one or more pyrolytic carbon layers and a carbide layer. In specific forms, the carbide layer comprises silicon carbide, zirconium carbide, or a combination thereof.

In various embodiments, the nuclear fuel particle comprises a multilayer coating structure. In certain forms, the multilayer coating structure comprises an inner coating layer, an intermediate coating layer, and an outer coating layer. In particular forms, the multilayer coating structure comprises an inner pyrolytic carbon layer, an intermediate carbide layer, and an outer pyrolytic carbon layer. In specific implementations, the intermediate carbide layer comprises silicon carbide. In other specific implementations, the intermediate carbide layer comprises zirconium carbide.

In further forms, the nuclear fuel particle comprises a buffer layer positioned between the kernel and an adjacent coating layer. In certain implementations, the buffer layer comprises carbon. In particular forms, the buffer layer comprises porous carbon or pyrolytic carbon. In specific arrangements, the buffer layer is disposed between the kernel and an inner pyrolytic carbon layer.

In various forms, the one or more coating layers substantially continuously surround the kernel. In certain implementations, the one or more coating layers are conformal to the outer surface of the kernel. In particular forms, the one or more coating layers are substantially concentric with the kernel. In specific embodiments, the coated particle is substantially spherical.

In certain arrangements, the nuclear fuel particle comprises at least one coating layer, at least two coating layers, at least three coating layers, or at least four coating layers surrounding the kernel. In particular forms, the nuclear fuel particle comprises a first coating layer comprising carbon, a second coating layer comprising carbide, and a third coating layer comprising carbon. In specific embodiments, the carbide comprises silicon carbide or zirconium carbide.

In certain implementations, the one or more coating layers are deposited on the kernel by chemical vapor deposition, physical vapor deposition, fluidized-bed coating, or combinations thereof. In particular forms, the one or more coating layers comprise deposited pyrolytic carbon and deposited silicon carbide. In other particular forms, the one or more coating layers comprise deposited pyrolytic carbon and deposited zirconium carbide.

In a particular configuration, the nuclear fuel particle comprises the uranium nitride nuclear fuel kernel, an inner carbon-containing layer surrounding the kernel, a barrier layer surrounding the inner carbon-containing layer, and an outer carbon-containing layer surrounding the barrier layer. In certain forms, the inner carbon-containing layer and the outer carbon-containing layer independently comprise pyrolytic carbon. In specific implementations, the barrier layer comprises silicon carbide. In other specific implementations, the barrier layer comprises zirconium carbide. In certain forms, the nuclear fuel particle is a tristructural isotropic fuel particle or a coated fuel particle having a tristructural isotropic-type layer arrangement.

A method of preparing a uranium nitride nuclear fuel kernel is provided. The method includes preparing a uranium source and a feedstock. The feedstock includes hexamethylenetetramine, urea, and a carbon source. A sintering additive and the uranium source (e.g., uranyl nitrate solution) are combined to form an additive solution. The additive solution and the feedstock are combined to form a gelation broth. Droplets of the gelation broth are formed. The droplets of the gelation broth are gelled to form gelled microspheres. The gelled microspheres are heated in a nitrogen-containing atmosphere to convert the gelled microspheres to a uranium nitride nuclear fuel kernel. The sintering additive is selected from the group consisting of (i) a metal oxide); (ii) a salt; and (iii) combinations of (i) and (ii). The (i) metal oxide is selected from the group consisting of zirconium dioxide, hafnium oxide, gadolinium oxide, and combinations thereof. The (ii) salt includes an additive cation and an additive anion. The additive cation is selected from the group consisting of zirconium, hafnium, gadolinium, and combinations thereof.

The method includes the step of preparing a uranium source. Generally, the uranium source is a uranyl nitrate solution. Preparing the uranyl nitrate solution may include forming an aqueous solution containing uranyl nitrate. The solution may be acidic and, in particular implementations, may comprise nitric acid. The uranyl nitrate solution may be prepared by dissolving a uranium-containing oxide in nitric acid and water. In certain implementations, the uranium-containing oxide comprises triuranium octoxide. Triuranium octoxide may be prepared by thermally reducing uranium trioxide prior to dissolution. Residual solids may be allowed to settle, and the uranyl nitrate solution may then be decanted. The uranyl nitrate solution may comprise an acid deficient uranyl nitrate solution. The uranyl nitrate solution may be prepared in accordance with any of the foregoing embodiments relating to the uranyl nitrate component of the precursor composition, including with respect to solvent, acidity, uranium concentration, and temperature. The uranyl nitrate solution may be chilled prior to use.

The method includes the step of preparing a feedstock comprising hexamethylenetetramine, urea, and a carbon source. The feedstock may comprise a solution including hexamethylenetetramine, urea, and the carbon source. Water, and in particular deionized water, may be included as a solvent. The feedstock may be mixed to provide a substantially uniform solution prior to combination with the uranyl nitrate solution. The hexamethylenetetramine, urea, and carbon source may be provided in accordance with any of the foregoing embodiments relating to the precursor composition, including with respect to composition, concentration, and relative amount. The carbon source may be selected and provided to yield a desired carbon-to-uranium ratio in the gelation broth. The feedstock may be prepared at a selected volume and may be chilled prior to combination with the uranyl nitrate solution.

The method includes the step of combining a sintering additive and the uranyl nitrate solution to form an additive solution. The sintering additive may comprise any of the foregoing additive cations, additive anions, salts, concentrations, relative amounts, and solution compositions described with respect to the precursor composition. The sintering additive may be dissolved in the uranyl nitrate solution or may be separately prepared and introduced into the uranyl nitrate solution. The additive solution may be mixed to provide a substantially uniform solution prior to combination with the feedstock.

The method includes the step of combining the additive solution and the feedstock to form a gelation broth. The additive solution and the feedstock may be combined under mixing. In certain implementations, the additive solution is added to the feedstock. In other implementations, the feedstock is added to the additive solution. The combining step may be carried out at a reduced temperature, and the gelation broth may be maintained at a reduced temperature prior to droplet formation.

The method includes forming droplets of the gelation broth. Droplet formation may be carried out by dispensing, dripping, extruding, or otherwise issuing the gelation broth through an opening to produce discrete droplets. The opening may comprise a needle, a nozzle, an orifice plate, a capillary, or another droplet-forming outlet. In certain implementations, the gelation broth is delivered through a needle. In particular implementations, the needle is a 10-gauge to 25-gauge needle, 12-gauge to 22-gauge needle, or 14-gauge to 18-gauge needle. In a specific implementation, the needle is a 16-gauge needle.

Droplet formation may be carried out under flow conditions selected to provide a desired droplet size distribution. The gelation broth may be delivered at a flow rate of 5 mL/min to 60 mL/min, 10 mL/min to 45 mL/min, 15 mL/min to 35 mL/min, or 20 mL/min to 30 mL/min. In a specific implementation, the gelation broth is delivered at a flow rate of 27.0 mL/min.

The droplets may be formed under vibration-assisted conditions. Vibration may be applied to the gelation broth, the droplet-forming outlet, or both. The vibration frequency may be 10 Hz to 100 Hz, 20 Hz to 80 Hz, 30 Hz to 60 Hz, or 40 Hz to 50 Hz. In a specific implementation, the vibration frequency is 42.7 Hz.

Droplet size may be selected to provide a desired microsphere size or final kernel size following subsequent processing. The formed droplets may have an average droplet diameter of 1.0 mm to 5.0 mm, 1.5 mm to 4.0 mm, 2.0 mm to 3.5 mm, or 2.4 mm to 3.0 mm. In a specific implementation, the formed droplets have an average droplet diameter of 2.7 mm.

Droplet formation may be conducted to provide a selected final kernel diameter following gelation and thermal conversion. The selected final kernel diameter may be 300 microns to 1500 microns, 500 microns to 1200 microns, 650 microns to 950 microns, or 750 microns to 850 microns. In a specific implementation, droplet formation is conducted to provide a final kernel diameter of 800 microns.

The gelation broth may be maintained at a reduced temperature during droplet formation. The temperature of the gelation broth during droplet formation may be 0° C. to 25° C., 2° C. to 20° C., 4° C. to 15° C., or 5° C. to 10° C. The droplets may be substantially spherical upon formation.

The method includes gelling the droplets of the gelation broth to form gelled microspheres. Gelling may be carried out by contacting the droplets with a heated gelling medium. The gelling medium may comprise silicone oil. In certain implementations, the droplets are combined with heated silicone oil. The silicone oil may be static or flowing. In particular implementations, the droplets are ejected into flowing silicone oil.

The silicone oil may be maintained at a temperature effective to initiate gelation of the droplets. The temperature of the silicone oil may be 40° C. to 120° C., 50° C. to 100° C., 60° C. to 80° C., or 65° C. to 75° C. In a specific implementation, the silicone oil is heated to 70° C.

The droplets may be collected after contact with the silicone oil. Collection may be carried out using a basket, a screen, a mesh structure, or another collection member. In certain implementations, the droplets are collected in a wire-mesh basket.

The droplets may remain in the heated silicone oil for a time sufficient to form gelled microspheres. The residence time in the heated silicone oil may be 1 minute to 60 minutes, 5 minutes to 40 minutes, 10 minutes to 30 minutes, or 15 minutes to 25 minutes. In a specific implementation, the droplets are aged in the heated silicone oil for 20 minutes.

Following gelation, the gelled microspheres may be removed from the silicone oil and drained. The gelled microspheres may thereafter be washed to remove residual silicone oil and additional soluble species. In certain implementations, the gelled microspheres are washed one or more times with an organic solvent. In particular implementations, the organic solvent comprises trichloroethylene. The gelled microspheres may also be washed with an aqueous basic solution. The aqueous basic solution may comprise ammonium hydroxide. The ammonium hydroxide may have a concentration of 0.5 M to 5.0 M, 1.0 M to 3.0 M, or 1.25 M to 2.0 M. In a specific implementation, the ammonium hydroxide has a concentration of 1.5 M.

The washing step may include multiple wash cycles. The gelled microspheres may be washed 1 time to 10 times, 2 times to 8 times, or 3 times to 6 times with one or more wash media. In certain implementations, the gelled microspheres are washed four times with trichloroethylene and four times with ammonium hydroxide. After washing, the gelled microspheres may be dried, size classified, or both prior to thermal conversion.

The method includes heating the gelled microspheres in a nitrogen-containing atmosphere to convert the gelled microspheres to a uranium nitride nuclear fuel kernel. The heating step may include carbothermic reduction-nitridation of the gelled microspheres. The nitrogen-containing atmosphere may comprise nitrogen gas, ammonia, forming gas including nitrogen, or another nitrogen-bearing atmosphere effective to convert uranium-containing material to uranium nitride. In particular implementations, the nitrogen-containing atmosphere comprises flowing nitrogen.

In certain implementations, heating the gelled microspheres in the nitrogen-containing atmosphere comprises heating according to a rapid conversion profile. The rapid conversion profile may include heating the gelled microspheres to a peak conversion temperature under nitrogen without an extended multistage heat-up profile in argon prior to nitridation. The peak conversion temperature may be 1400° C. to 2200° C., 1500° C. to 2100° C., 1600° C. to 2000° C., or 1700° C. to 1900° C. In particular implementations, the peak conversion temperature is 1800° C. The heating rate to the peak conversion temperature may be 1° C./min to 20° C./min, 3° C./min to 15° C./min, 5° C./min to 12° C./min, or 8° C./min to 10° C./min. In a specific implementation, the heating rate is 10° C./min. The gelled microspheres may be maintained at the peak conversion temperature for 7 hours to 13 hours, 8 hours to 12 hours, or 9 hours to 11 hours. In a specific implementation, the gelled microspheres are maintained at the peak conversion temperature for 10 hours.

The rapid conversion profile may be conducted in flowing nitrogen during heat-up to the peak conversion temperature and during the hold at the peak conversion temperature. Following the nitrogen heating step, the method may further include changing the furnace atmosphere from nitrogen to argon while maintaining the uranium nitride nuclear fuel kernel at an elevated temperature. The argon heating step may be carried out for 0 hours to 5 hours, 1 hour to 5 hours, 1 hour to 4 hours, or 3 hours to 5 hours. In particular implementations, the argon heating step is carried out for 5 hours. The elevated temperature during the argon heating step may be 1400° C. to 2200° C., 1500° C. to 2100° C., 1600° C. to 2000° C., or 1700° C. to 1900° C. In a specific implementation, the argon heating step is carried out at 1800° C.

Heating may be conducted in a furnace under a flowing nitrogen-containing atmosphere. The heating step may include a temperature ramp to a selected peak temperature, a hold at the selected peak temperature for a selected duration, and cooling following conversion. In certain implementations, the heating step converts the gelled microspheres to uranium nitride kernels having a substantially spherical form.

The method may further include heating the uranium nitride nuclear fuel kernel in argon following carbothermic reduction-nitridation. The argon heating step may be carried out after formation of the uranium nitride nuclear fuel kernel and prior to coating of the kernel. The uranium nitride nuclear fuel kernel may be heated in argon for 1 hour to 5 hours, 2 hours to 4 hours, or 2.5 hours to 3.5 hours. In a specific implementation, the uranium nitride nuclear fuel kernel is heated in argon for 3 hours. In some embodiments, especially embodiments where the sintering additive comprises titanium, the argon heating step may be omitted or happen for a time of 5 to 60 minutes, alternatively 10 to 50 minutes, or alternatively 20 to 40 minutes.

The argon heating step may be carried out under a flowing argon atmosphere. The argon atmosphere may comprise substantially pure argon or argon having incidental impurities. The argon heating step may be conducted in the same furnace used for carbothermic reduction-nitridation or in a different furnace. The argon heating step may be carried out at a temperature effective to condition the uranium nitride nuclear fuel kernel following nitridation. The temperature may be 1400° C. to 2200° C., 1600° C. to 2100° C., 1700° C. to 2000° C., or 1750° C. to 1950° C. In certain implementations, the temperature is 1800° C.

The argon heating step may follow heating in the nitrogen-containing atmosphere without intermediate cooling to room temperature, or may be carried out after cooling and reintroduction of the uranium nitride nuclear fuel kernel to a furnace. In certain implementations, the atmosphere is changed from the nitrogen-containing atmosphere to argon after completion of carbothermic reduction-nitridation.

The uranium nitride nuclear fuel kernel heated in argon may thereafter be cooled and recovered for subsequent handling, classification, coating, or incorporation into a nuclear fuel particle.

### EXAMPLES

The following examples are provided to illustrate certain embodiments of the invention and are not intended to limit the scope of the invention in any manner. The examples describe specific materials, compositions, process conditions, and parameters; however, it will be understood that variations in such details may be made without departing from the spirit and scope of the invention as defined by the appended claims. All modifications and equivalents apparent to those skilled in the art are intended to be included within the scope of the invention.

TABLE 1
Materials
Materials

Gadolinium nitrate hexahydrate (Gd(NO₃)₃•6H₂O,
REO 99.5%), Fisher Scientific
Zirconium tetrachloride (ZrCl₄, Reactor Grade 99.5%), Fisher Scientific
Hafnium tetrachloride (HfCl₄, 99.9%), Fisher Scientific
Gadolinium trichloride (GdCl₃, Anhydrous 99.9%), Fisher Scientific
Hexamethylene tetramine (HMTA, Certified ACS), Fisher Scientific
Urea (Crystalline/Reagent Grade, MP Biomedicals), Fisher Scientific
Ammonium hydroxide (NH₄OH, ACS Reagent), Fisher Scientific
Nitric acid (HNO₃, 69.0-70.0%, JT Baker), Fisher Scientific
Hydrochloric acid (HCl, ACS Reagent 37%), Fisher Scientific
Titanium tetrachloride (TiCl₄, Reagent Plus 99.9%), Millipore Sigma
Ammonium chloride (NH₄Cl, Reagent Plus ≥99.5%), Millipore Sigma
Zirconyl nitrate hydrate (ZrO(NO₃)₂•H₂O, 99%), Millipore Sigma
Trichloroethylene (TCE, >99.5% ACS), VWR
Ultrahigh purity Argon (UHP Ar, AR UHP300BA), AirGas
Ultrahigh purity Nitrogen (UHP N₂, NI UHP300), AirGas
Soluble carbon solution TPX-101, Cabot Corporation
Uranium trioxide (UO₃), Cameco
Deionized water (DI)
Lanthanum hexaboride (LaB₆, 660b), NIST
Silicone oil (E200 100 cS), Esco Products, Inc

### General Procedure 1: Acid Deficient Uranyl Nitrate (ADUN Preparation)

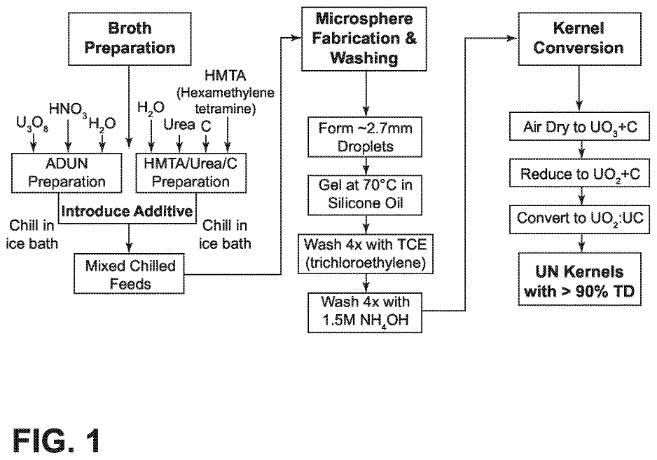

The ADUN feedstock was prepared by first converting UO₃ powder to U₃O₈ through a thermal treatment in air at about 700° C. for several hours. The resulting U₃O₈ was then dissolved in concentrated nitric acid to form a uranyl nitrate solution. Finally, the solution was diluted with deionized water to the target concentration for use as the ADUN feedstock. U₃O₈ powder was dissolved to prepare an acid-deficient uranyl nitrate (ADUN) solution by charging the oxide and deionized water to a stirred vessel to form a slurry, followed by controlled addition of concentrated nitric acid. The acid was introduced gradually while maintaining active cooling to control the exothermic reaction and hold the dissolution temperature at approximately 50-60° C. The oxide was provided in slight excess to ensure attainment of the desired solution composition. The solution composition was then adjusted, as needed, with additional nitric acid and/or water to achieve the target uranium concentration and NO₃:U mole ratio prior to further processing. The residual solids were allowed to settle and the resulting ADUN was decanted with the density and pH measured to determine the uranium concentration and the NO₃—:U ratio (R), respectively. The ADUN preparation method is shown in context in FIG. 1.

### General Procedure 2: HMTA/Urea/C (H/U/C) Preparation

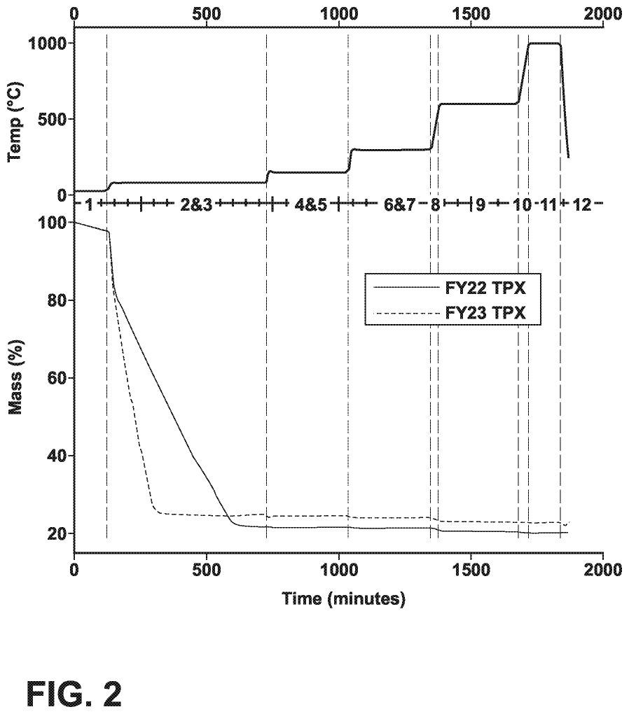

First, the soluble C solution is standardized to determine a C concentration. The stock solution density was measured and determined to be 1.177 g/mL. The C solution was standardized by heating the C solution in 100 ccm flowing UHP Ar with the temperature profile depicted in FIG. 2 and Table 2. Using the density and mass change data, it was determined that the C concentration of the solution was 18.73 M.

TABLE 2
Soluble C Standardization profile using 100 ccm flowing UHP Ar

| Stage | Temperature | Hold Time |
|---|---|---|
| 1 | Hold at 20° C. | 2 hours |
| 2 & 3 | Heat to 80° C. at 10° C./min | 5 hours |
| 4 & 5 | Heat to 150° C. at 10° C./min | 5 hours |
| 6 & 7 | Heat to 300° C. at 10° C./min | 5 hours |
| 8 & 9 | Heat to 600° C. at 10° C./min | 5 hours |
| 10 & 11 | Heat to 1000° C. at 10° C./min | 2 hours |
| 12 | Cool to 20° C. at 30° C./min | N/A |

The H/U/C feedstock was prepared by weighing sufficient amounts of HMTA, urea, and soluble C solution to produce concentrations of 3.2 M, 3.2 M, and 5.415 M (C:U ratio of 2.2), respectively. Enough DI was added to reach ~90% of the final volume and stirred overnight. The solution was transferred to an appropriately sized volumetric flask and the mixing container was rinsed with DI. The rinse solution was transferred to the volumetric flask and enough DI was added to reach the fill line. The density was calculated using the mass and volume of the solution so the broth feeds can be measured accurately.

### General Procedure 3: Sintering Additive Preparation

Each of Sintering Additives 1-8 was dissolved in DI. Dissolution is exothermic and can produce harmful acid vapors. Stock solutions of HCl and HNO₃ were prepared by diluting the concentrated acids to 5 M with DI. The dissolution process generates heat, so the diluted acids were allowed to cool to room temperature. The density of the nominal 5 M acid was measured to determine the concentration. The Sintering Additives and concentrations are shown in Table 3 below.

TABLE 3
Compositions of Sintering Additives 1-8

| | | | Cation | Anion |
|---|---|---|---|---|
| | | | Concen- | Concen- |
| | Anion | Cation | tration | tration |
| Sintering Additive 1 | Nitrate | Zr⁴⁺ | 1.0M | 3.0M |
| Sintering Additive 2 | Nitrate | Gd³⁺ | 1.0M | 3.0M |
| Sintering Additive 3 | Chloride | Ti⁴⁺ | 1.0M | 4.75M |
| Sintering Additive 4 | Chloride | Zr⁴⁺ | 1.0M | 4.75M |
| Sintering Additive 5 | Chloride | Hf⁴⁺ | 1.0M | 4.75M |
| Sintering Additive 6 | Chloride | Gd³⁺ | 1.0M | 4.75M |
| Sintering Additive 7 | Chloride | UO₂²⁺ | 1.0M | 4.75M |
| Sintering Additive 8 | Chloride | NH₄⁺ | 4.75M | 4.75M |

### General Procedure 4: Microsphere Synthesis & Processing

ADUN, H/U/C, and Sintering Additive Solutions were weighed and disposed in separate bottles to produce 150 mL solutions. The individual components were chilled in an ice bath before mixing. The additive solution was combined with the ADUN, followed by combination with the H/U/C solution, to give a fuel precursor broth. The fuel precursor broth was thoroughly mixed and transferred to a chilled broth pot. Droplets sized to target an 800 μm final kernel diameter were formed by flowing the fuel precursor broth at 27.0 mL/min through a 16-gauge needle with a vibration frequency of 42.7 Hz using the gelation system. Broth properties are shown in Table 4 below.

TABLE 4
Broth Properties

| U Concentration | HMTA:U Ratio | C:U Ratio | Metal Additive Amount |
|---|---|---|---|
| 1.30M | 1.3 | 2.2 | 1.74 at % of U |

The droplets were ejected into flowing silicone oil heated to 70° C. and collected in a wire-mesh basket. The collected microspheres were aged for 20 minutes in the heated silicone oil before being removed and drained of oil. The aged microspheres were washed four times with TCE. The microspheres were then washed in 1.5 M NH₄OH four times. The used NH₄OH solution was measured for electrical conductivity to observe how washing was progressing. If the final wash had a conductivity below 2 mS, then the washing was complete. Otherwise, another NH₄OH wash was conducted. The washed microspheres were then allowed to air dry in trays within a fume hood for 2 days. The air-dried microspheres were rolled to remove oblong microspheres and fragments and then sieved into separate size fractions.

### General Procedure 5: Microsphere Conversion to UN Kernels

The microspheres were converted in a Netzsch STA 449 F3 Jupiter (STA) using UHP Ar and N₂ passed through an Agilent BOT-4 oxygen getter. The conversion was performed in a graphite crucible with a W liner to observe different stages of conversion. The graphite furnace on the STA was calibrated and controlled using the furnace thermocouple. The furnace thermocouple was used to bypass the sample carrier thermocouple due to breakage during nitridation. The furnace was leak checked using high vacuum to ensure an inert environment during conversion. Each sample was loaded, and the chamber was evacuated to about 3 mbar and back filled with UHP Ar before starting each run. A rapid profile was used to determine the efficacy of each Sintering Additive 1-8 under accelerated conversion conditions. The gas and temperature profiles are shown below.

TABLE 5
Gas and Temperature Profiles

| Stage | Temperature | Gas Flow |
|---|---|---|
| 1 | Heat to 1800° C. at 10° C./min | N₂ at 100 ccm |
| 2 | Hold at 1800° C. at 10 hours | N₂ at 100 ccm |
| 3 | Hold at 1800° C. for 0, 1, 3, | Ar at 100 ccm |
| | or 5 h | |
| 4 | Cool to 20° C. at 30° C./min | Ar at 100 ccm |

For each conversion run, the selected gas and temperature profile was carried out under the specified argon and nitrogen flow conditions. Following completion of the programmed cooling step, the sample was maintained under argon until recovery from the chamber.

TABLE 6
Gas and Temperature Profiles

| Stage | Temperature | Gas Flow |
|---|---|---|
| 1 | Heat to 700° C. at 3° C./min | Ar at 3.87 ccm (2 mL/min/gU) |
| 2 | Heat to 1400° C. at 5° C./min | Ar at 3.87 ccm (2 mL/min/gU) |
| 3 | Heat to 1800° C. at 1° C./min | Ar at 19.3 ccm (10 mL/min/gU) |
| 4 | Hold at 1800° C. for 1 hour | Ar at 19.3 ccm (10 mL/min/gU) |
| 5 | Hold at 1800° C. for 10 hours | N₂ at 9.66 ccm (5 mL/min/gU) |
| 6 | Hold at 1800° C. for 30 | Ar at 9.66 ccm (5 mL/min/gU) |
| | minutes | |
| 7 | Cool to 20° C. at 30° C./min | Ar at 9.66 ccm (5 mL/min/gU) |

The UN kernels were characterized to determine their density and composition. The density was calculated by first measuring the average kernel mass and diameter. The average kernel volume was calculated from the diameter to determine the density. The kernels were characterized with X-ray diffraction (XRD) and composition was quantified using Rietveld analysis.

### Measurement of Average Kernel Mass

The envelope density was calculated by measuring the average kernel mass and diameter. The average kernel mass was determined by first weighing a batch of approximately 500 kernels on a Mettler Toledo XP-504 analytical balance (+0.1 mg). The batch of kernels was then imaged with a Leica DMRX microscope equipped with a Leica DFC495 digital camera. The image was analyzed with in-house MATLAB software to count the number of kernels in the batch to determine the average kernel mass (AKM). The process was repeated four more times to provide statistics.

### Measurement of Average Kernel Diameter

The average kernel diameter was determined by performing shadow imaging using a Leica DMRX microscope equipped with a Leica DFC495 digital camera. The microscope was calibrated before imaging began. Kernels were loaded into a custom assembly and viewed under the microscope. The full field of view was imaged using multiple frames to provide adequate sampling. The separate images were analyzed using in-house MATLAB software to measure the individual average kernel diameter. The individual measurements were averaged to determine numerical and volumetric diameters.

### Geometric Calculation of Volumetric Diameter and Envelope Density

The envelope density was calculated by first calculating the average kernel volume (V̅ₖₑᵣₙₑₗ) using the following equation:

$${\overline{V}}_{kernel} ( {mm}^{3} ) = \frac{π}{6 \cdot n} {\sum }_{n} {D}_{i}^{3} ( mm )$$

Where Dᵢ is average diameter in millimeters, for each segmented kernel, and n is the number of kernels segmented. Using this value, the envelop density (ρₑₙᵥ) was calculated according to the below equation. Mercury (Hg) porosimetry is the preferred method for determining envelope density, but it requires larger amounts of sample material to produce accurate data. The recommended method is to use Hg porosimetry when high fidelity measurements are required, but the calculation described above is suitable for developmental purposes.

$${ρ}_{e n v} ( g / mL ) = \frac{AKM ( mg )}{{\overline{V}}_{kernel} ( {mm}^{3} )}$$

### X-Ray Diffraction and Rietveld Analysis of UN Kernels

The UN kernels were characterized with XRD to determine final composition. Roughly 50 mg were ground in isopropanol (IPA) using a mortar and pestle. An aliquot was loaded onto a low background silica disk (MTI) and allowed to dry. A NIST LaB6 standard was mixed with the remaining ground sample. Another aliquot was loaded onto a separate disk and allowed to dry. A Kapton disk was applied to the disks for containment. The disks were loaded into a Bruker D2 Phaser with Cu Kα source (1.5406 Å) and scanned from 10° to 110°. The resulting scans were analyzed using GSAS-II to determine phase composition.

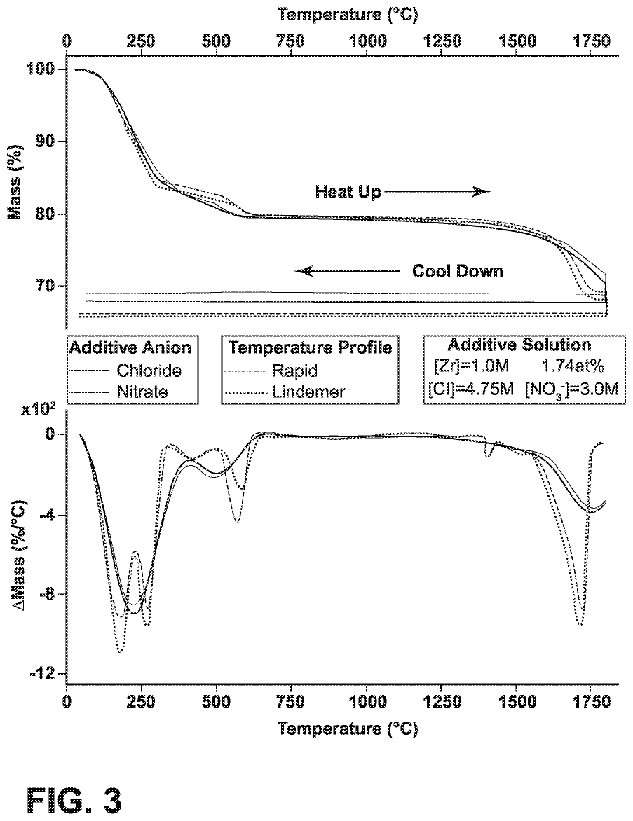

The microsphere-to-kernel conversion profiles were compared according to the different methodologies to observe how the methods changed the final materials properties of the kernels. As shown in the TG graphs of FIG. 3, the mass change and temperature-dependent mass change curves are plotted as a function of temperature for conversion of UN kernels. The broths were doped with Zr-Chloride- and Zr-Nitrate-based additives. The UN kernels were converted using the rapid and slower conversion methods.

Microspheres with Zr-chloride and Zr-nitrate added were used as a comparison to determine if the additive can improve densification, even if an optimized conversion profile is used. As shown in FIG. 3, the material loses mass at roughly the same temperature, although ramp rates also impact mass loss. The slower ramp rates of the slower method reveal a separation of physiosorbed and chemisorbed water being lost, but the rapid method blends the two together. Generally, a slower ramp rate improves densification, resulting in a hotter temperature needed for the same reaction rate. Additionally, the slower and rapid methods have different behaviors when heated to 1800° C. The slower profile causes the microspheres to lose more mass before reaching peak temperature, changing the reaction pathway.

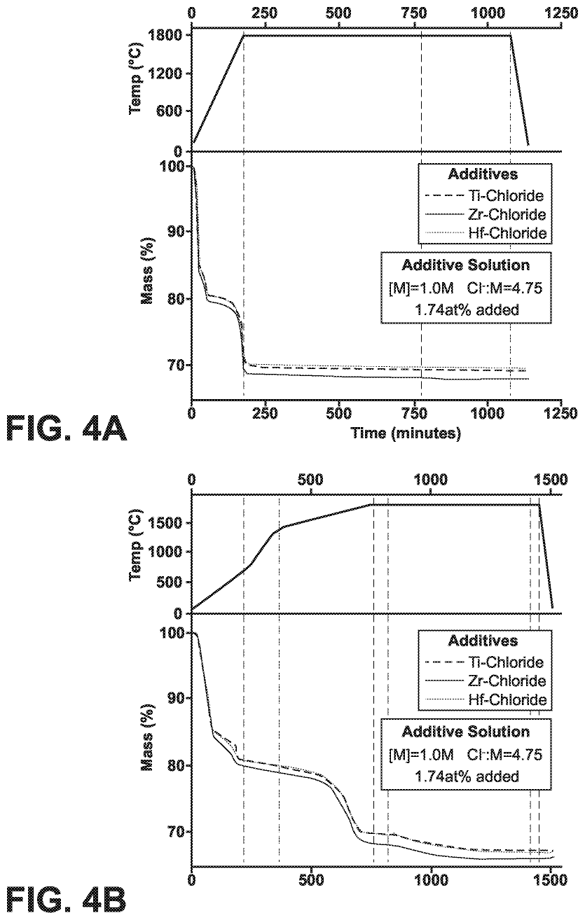

Group IV element-based (Ti, Zr, and Hf) additives were tested using chloride based feedstock. As shown in FIGS. 4A and 4B, the TG curves indicate Zr-doped UN kernels undergo additional mass loss relative to their Ti- and Hf-based counterparts for microspheres undergoing conversions using the rapid and slower methods. This mass loss stems from a combination of extra water and other byproducts but is also the result of mass loss from the carbothermic reduction and nitridation process. The Zr- and Hf-doped microspheres resulted in high density UN kernels when using the rapid conversion method, but the Ti-doped microspheres did not. The Ti-doped microspheres even resulted in a lower density than the undoped microspheres, suggesting Ti inhibits grain growth and densification.

TABLE 7
Absolute and Theoretical Density

| | Absolute | Theoretical | Theoretical |
|---|---|---|---|
| Group IV | Density | Density | Density |
| Cation | (g/mL) | (g/mL) | (%) |
| No Additive | 8.13 | — | — |
| Ti | 7.26 | 13.71 | 52.9 |
| Zr | 13.67 | 13.91 | 98.3 |
| Hf | 13.38 | 13.40 | 99.9 |

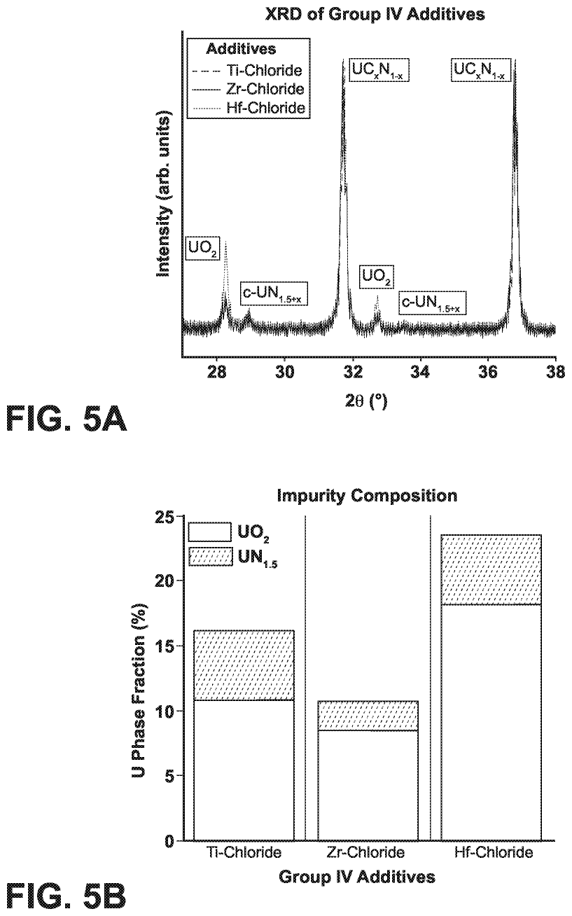

The converted microspheres were characterized with XRD, shown in FIGS. 5A and 5B, to observe the effect the various Group IV cations have on the final composition. The different additives resulted in the same three phases: the main UCₓN₁₋ₓ phase, the primary impurity phase (UO₂), and the secondary impurity phase (c-UN_{1.5+x}). Overall, the various dopants are arranged Zr- (11.2 wt. %), Ti- (17.0 wt. %), and Hf-doped (24.6 wt. %) kernels by increasing impurity content.

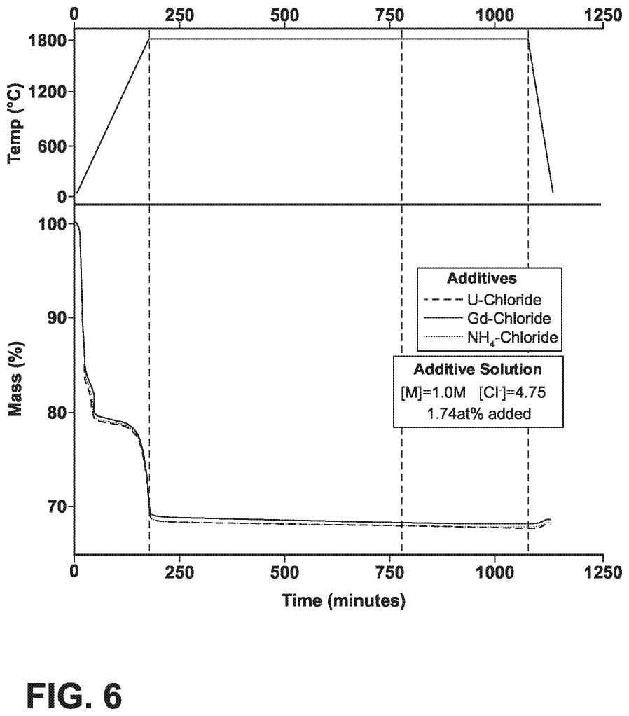

The U-Chloride and NH₄-Chloride additives were used for baseline comparison because they do not add any additional elements to the microspheres. The Gd-Chloride additive was used for comparison with the nitrate-based additives. Overall, the microspheres with the various additives exhibited similar mass change behavior when the rapid conversion profile was used, as shown in FIG. 6. Additionally, these microspheres had densities comparable to microspheres without additives. The differences in density are believed to result from the variability of microsphere synthesis and not the additives themselves. These results suggest that Cl is not the active sintering component.

TABLE 8
Absolute Density

| | Absolute |
|---|---|
| Other Cations | Density (g/mL) |
| No Additive | 8.13 |
| UO₂²⁺ | 7.72 |
| Gd³⁺ | 8.58 |
| NH₄⁺ | 7.88 |

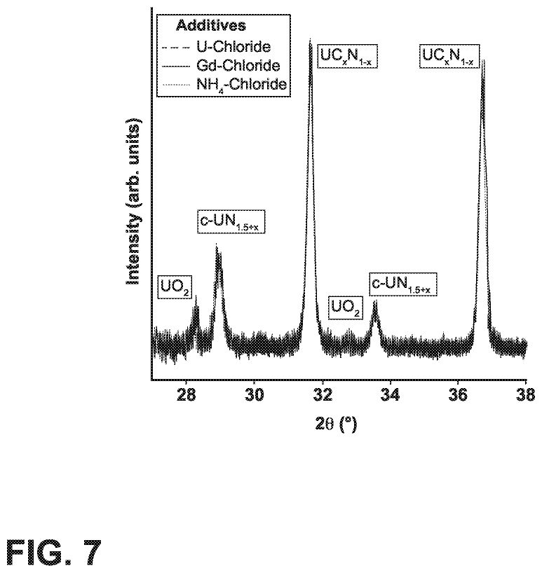

The converted kernels were measured with XRD to observe the effect the additives have on the final composition, as shown in FIG. 7. All three additives resulted in similar composition. The kernels exhibited an elevated c-UN_{1.5+x} phase relative to their Group IV additive counterparts, which is believed to be caused by the increased surface area. The mass change data show a pronounced increase in mass during cooldown as shown in FIG. 6. This is believed to be because of the material reaction with N₂ via the reverse reaction shown in the following equation.

$$\frac{1}{2} {U}_{2} {N}_{3} \to UN + \frac{1}{4} {N}_{2}$$

However, the Ti-doped kernels do not show this trend, despite the lowest density and the most surface area.

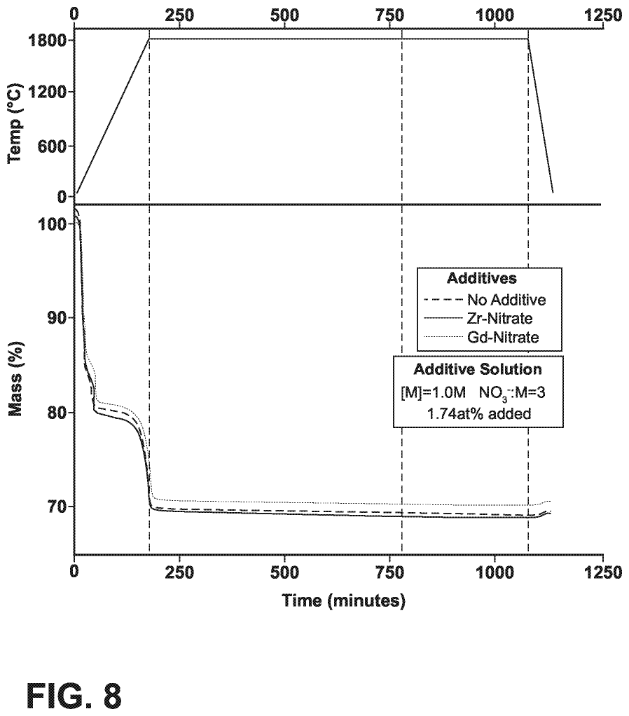

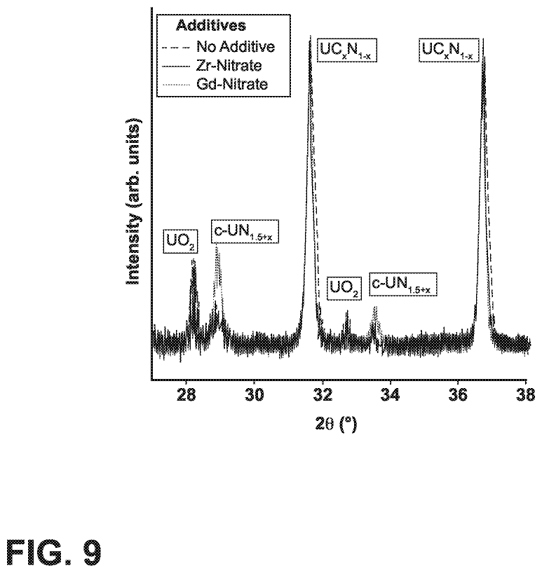

Microspheres were synthesized with nitrate-based additives to verify the cation is the active component for improved sintering and densification. Overall, the microspheres with the nitrate-based additives exhibited similar behavior to their chloride-based counterparts. The microspheres with no additive and with the Gd-Nitrate additive produce lower density kernels, as shown in the below Table, that demonstrate a pronounced mass uptake as shown in FIG. 8 during cooldown. This resulted in a higher c-UN_{1.5+x} content shown in FIG. 9. Microspheres with Gd-Nitrate additive produced kernels were approximately 12% more dense than the Gd-Chloride sample. The Zr-doped microspheres resulted in 2% less dense kernels.

TABLE 9
Absolute Density

| | Absolute |
|---|---|
| Other Cations | Density (g/mL) |
| No Additive | 8.13 |
| Zr⁴⁺ | 13.31 |
| Gd³⁺ | 9.51 |

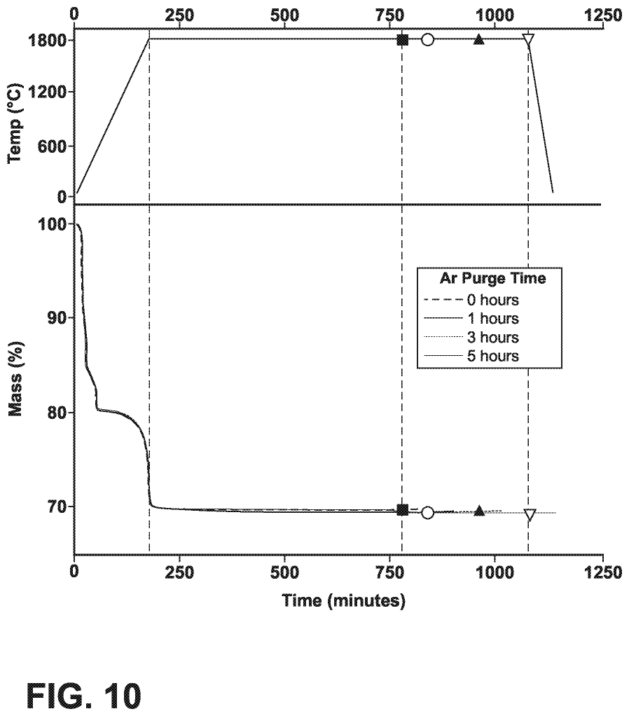

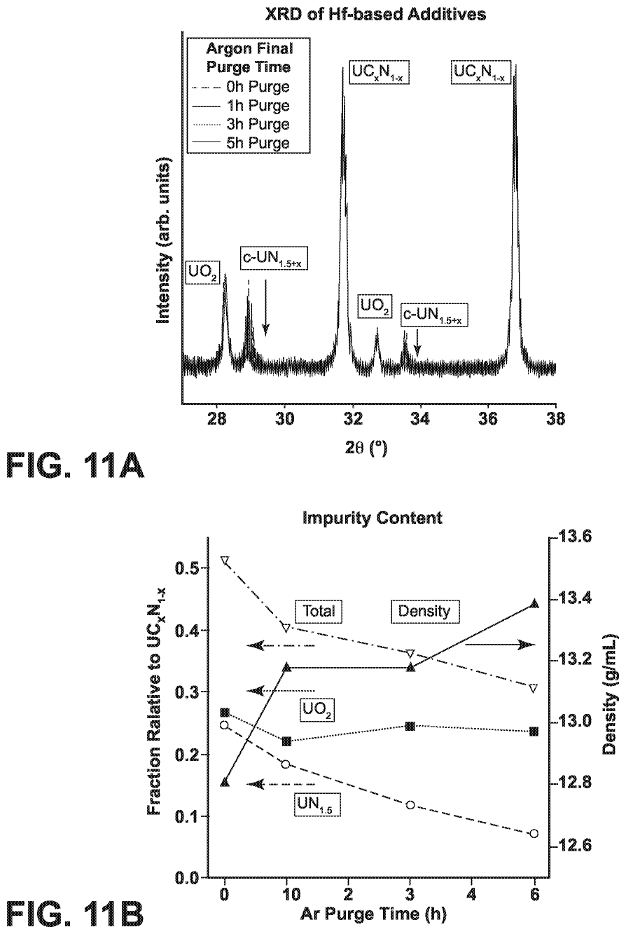

Further experiments testing the conversion profile for the Hf-chloride solution were performed using these microspheres to better determine how to make phase-pure UN kernels. In particular, the Ar purge at 1800° C. was varied to observe the change in concentration of the c-UN_{1.5+x} phase. Mass change data for the material revealed only subtle differences between purge times as shown in FIG. 10. The molar mass of UN (252 g/mol) is 97.3% of c-UN_{1.5+x} (259 g/mol), making the maximum mass change about 50 mg for 3 g of starting material, assuming there is only UN remaining in the sample. However, XRD scans indicated residual c-UN_{1.5+x} as well as UO₂ impurities as shown in FIG. 11A. Longer Ar purges at 1800° C. led to a decrease in c-UN_{1.5+x} with less than 10% relative to UCₓN₁₋ₓ (5.5 wt %) remaining after purging for 5 hours as shown in FIG. 11B. The theoretical density of each material was calculated based on the composition and can be seen in the table below. Overall, the increase in density from additional purge time can mostly be attributed to a decrease in c-UN_{1.5+x} content and not additional densification.

TABLE 10
Absolute and Theoretical Density

| | | | |
|---|---|---|---|
| | Absolute | Theoretical | Theoretical |
| Ar Purge | Density | Density | Density |
| Time | (g/mL) | (g/mL) | (%) |

| | | | | |
|---|---|---|---|---|
| 0 | hours | 12.81 | 13.06 | 98.0 |
| 1 | hour | 13.18 | 13.23 | 99.6 |
| 3 | hours | 13.18 | 13.31 | 99.0 |
| 5 | hours | 13.38 | 13.40 | 99.9 |

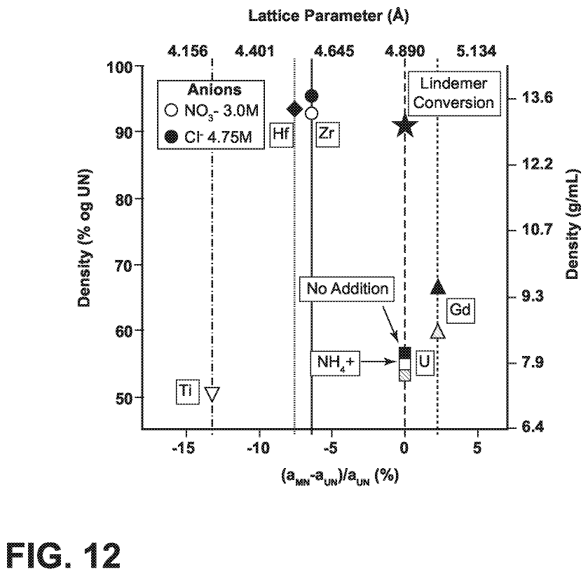

Sintering additives were added to UN fuel to improve density and tailor microstructure while maintaining the benefits of current fabrication methods. Various anions and cations were tested to determine the active component of the additives. It was established the cation is responsible for improved densification; the cations tested were Zr~Hf>>Gd>none~NH4>U>Ti in order of decreasing efficacy. The density was plotted as a function of lattice parameter of the corresponding metal nitride (MN) to observe trends in the sintering additive, as shown in FIG. 12. The difference between the crystal sizes of UN and MN causes the resulting lattices to be strained, improving atomic mobility. However, TiN has a significantly different lattice parameter than UN, most likely causing phase segregation and preventing the additive from having an effect. It is unclear if Ti slows grain growth and densification as opposed to simply being inactive in the process.

The results from using Gd-based additives in conjunction with the Hf- and Zr-based additives indicate the difference in lattice size is responsible, but there are significant gaps in lattice parameter between ZrN/HfN and TiN or UNₓ. The table below shows suggested elements including lattice parameter and the difference relative to UN.

TABLE 11
Lattice Parameters and Difference

| | Lattice | |
|---|---|---|
| Cation | Parameter (Å) | Difference (%) |
| U | 4.890 | N/A |
| Nb | 4.394 | −10.1 |
| Yb | 4.757 | −2.1 |
| Nd | 5.141 | +5.1 |
| La | 5.286 | +8.1 |

The use of sintering additives allows the kernels to be converted using a different temperature and gas profile, but that would change the reaction pathway. A slower profile converts the microspheres from UO₂+C to UN in 2 stages: carbothermic reduction to UC and nitridation to UN. These reactions are shown below.

$$\frac{2}{3} {UO}_{2} + 2 C \to \frac{2}{3} UC + \frac{4}{3} CO$$

$$\frac{1}{3} {UO}_{2} + \frac{2}{3} UC + \frac{1}{2} {N}_{2} \to UN + \frac{2}{3} CO$$

The rapid profile proceeds in 2 different stages: carbothermic reduction and nitridation to U₂N₃ and denitridation to UN. These reactions are shown below.

$${UO}_{2} + 2 C + \frac{3}{4} {N}_{2} \to \frac{1}{2} {U}_{2} {N}_{3} + 2 CO$$

$$\frac{1}{2} {U}_{2} {N}_{3} \to UN + \frac{1}{4} {N}_{2}$$

Converting from UO₂+C to UN reduces the mass by 15%. Roughly 80% of the microsphere mass participates in conversion, making the expected final mass equate to about 68%. The slower profile produces the expected mass change, but the rapid profile appears to be incomplete.

The gaseous species that react, N2 (28 g/mol) and CO (28 g/mol), have the same molecular weight, making the molecular difference in the two gases convenient to track the progress of reaction. The slower profile loses 66.7% of the expected mass in the first stage and 33.3% in the second stage. In contrast, the rapid profile should theoretically lose 75% of the expected mass in its first stage and 25% in the second stage. The slower profile roughly reaches the expected mass, indicating that the stages are fairly discrete. However, the rapid profile does not; additionally, the final mass of the converted kernels is higher than the expected value, suggesting the conversion to UN was incomplete.

Sintering additives also offer a way to produce highly-dense UN kernels while controlling the c-UN_{1.5+x} content. UN may be used as a nuclear fuel source, but there are concerns of decomposition to uranium sub-nitride (UNₓ, where x<1) at nuclear thermal propulsion (NTP) relevant temperatures (>2700 K). In NTP applications, the UN kernels would be coated with typical TRISO layers, but the SiC layer is replaced with ZrC to act as a protective barrier to hydrogen. The final TRISO particles can safely be exposed to elevated temperatures and hydrogen, but UN decomposition is still a concern.

The incorporation of the c-UN_{1.5+x} phase can be used to prevent the formation of UNₓ at NTP relevant temperatures. At those temperatures, the c-UN_{1.5+x} phase will preferentially decompose and increase the N activity, assuming the coating is hermetic. The increased N activity will then reduce the likelihood of UN decomposition, mitigating the deleterious effects of UNₓ formation.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all these features or that provide all the stated benefits, except to the extent otherwise expressly set forth in the issued claims. Any reference to claim elements in the singular, for example, using the articles “a,” “an,” “the” or “said,” is not to be construed as limiting the element to the singular.

1. A precursor composition for forming uranium nitride nuclear fuel, the precursor composition comprising:
a uranium source;
a carbon source; and
a sintering additive selected from the group consisting of:
(i) a metal oxide selected from the group consisting of zirconium dioxide, hafnium oxide, gadolinium oxide, and combinations thereof;
(ii) a salt including an additive cation and an additive anion;
wherein the additive cation is selected from the group consisting of zirconium, hafnium, gadolinium, and combinations thereof; and
(iii) combinations of (i) and (ii).

2. The precursor composition of claim 1,
wherein the sintering additive is a salt, and the additive cation is selected from the group consisting of zirconium, hafnium, and combinations thereof.

3. The precursor composition of claim 2,
wherein the additive cation is zirconium.

4. The precursor composition of claim 2,
wherein the additive cation is hafnium.

5. The precursor composition of claim 1,
wherein the uranium source is selected from the group consisting of uranyl nitrate, uranyl chloride, uranium dioxide, and combinations thereof.

6. The precursor composition of claim 1,
wherein the uranium source is uranyl nitrate, and the uranyl nitrate is present in an aqueous nitric acid solution.

7. The precursor composition of claim 1,
wherein the carbon source is provided in a solution comprising hexamethylenetetramine, urea, and distributed carbon.

8. The precursor composition of claim 1,
wherein the sintering additive is a salt, and the additive cation is present in an amount of 0.5 atomic % to 5 atomic % relative to uranium.

9. The precursor composition of claim 1,
wherein the carbon source is present in an amount providing a carbon-to-uranium ratio of 1:1 to 3:1.

10. A uranium nitride nuclear fuel kernel prepared from the precursor composition of claim 1 by carbothermic reduction-nitridation.

11. The uranium nitride nuclear fuel kernel of claim 10,
wherein the nuclear fuel kernel has a density of at least 12 g/cm³.

12. A nuclear fuel particle comprising:
the nuclear fuel kernel of claim 10; and
one or more coating layers surrounding the kernel.

13. A method of preparing a uranium nitride nuclear fuel kernel, the method comprising:
preparing a uranium source;
preparing a feedstock comprising hexamethylenetetramine, urea, and a carbon source;
combining a sintering additive and the uranium source to form an additive solution;
combining the additive solution and the feedstock to form a gelation broth;
forming droplets of the gelation broth;
gelling the droplets of the gelation broth to form gelled microspheres;
heating the gelled microspheres in a nitrogen-containing atmosphere to convert the gelled microspheres to uranium nitride nuclear fuel;
wherein the sintering additive is selected from the group consisting of:
(i) a metal oxide selected from the group consisting of zirconium dioxide, hafnium oxide, gadolinium oxide, and combinations thereof;
(ii) a salt including an additive cation and an additive anion, wherein the additive cation is selected from the group consisting of zirconium, hafnium, gadolinium, and combinations thereof; and
(iii) combinations of (i) and (ii).

14. The method of claim 13,
wherein the sintering additive is the salt, and the additive cation is selected from the group consisting of zirconium, hafnium, and combinations thereof.

15. The method of claim 13,
wherein the sintering additive is the salt, and the additive cation is zirconium.

16. The method of claim 13,
wherein the sintering additive is the salt, and the additive cation is hafnium.

17. The method of claim 13,
wherein gelling the droplets of the gelation broth comprises combining the droplets and heated silicone oil.

18. The method of claim 13,
wherein heating the gelled microspheres is conducted at a temperature between 1400° C. and 2200° C.

19. The method of claim 13,
wherein heating the gelled microspheres is conducted for 7 to 13 hours.

20. The method of claim 13, further comprising:
heating the uranium nitride nuclear fuel kernel in argon for 1 hour to 5 hours.
